(19) United States
(12) Patent Application Publication
(10) Pub. No.: US 2002/0105946 A1
(43) Pub. Date: Aug. 8, 2002

(54) Internet IP telephone switching system, internet-oriented IP telephone apparatus, internet IP telephone connection management method, telephone number automatic receiving/sending method, and computer readable medium on which an internet IP telephone switching program is recorded

(76) Inventor: Yoji Takeuchi, Chiba-Shi (JP)

Correspondence Address: YOUNG & THOMPSON, 745 SOUTH 23RD STREET 2ND FLOOR, ARLINGTON, VA, 22202

(21) Appl. No.: 10/067,825

(22) Filed: Feb. 8, 2002

(30) Foreign Application Priority Data
Feb. 9, 2001 (JP) 2001-075026

(51) Int. Cl. H04L 12/66; H04L 12/28

(52) U.S. Cl. 370/352; 370/419

(57) ABSTRACT

By effectively managing the IP address of a special internet-oriented IP telephone apparatus, the IP telephone apparatus can make a call directly to another IP telephone apparatus. Moreover, by connecting two calls of both a call over the internet and a call on the Public Switched Telephone Network (PSTN), phone call can be performed from the IP telephone apparatus to a PSTN telephone terminal, or from the PSTN telephone terminal to the IP telephone apparatus.

### BACKGROUND OF THE INVENTION

1. Field of the Invention:

This invention relates to an internet-oriented IP telephone switching system that enables voice communication between two parties over the internet, a special internet-oriented IP telephone apparatus for internet Voice-over-IP (VoIP) communication, a method for managing IP address of the special internet-oriented IP telephone apparatus, and a method for receiving and sending a telephone number between the special internet-oriented IP telephone apparatus and the Public Switched Telephone Network (PSTN) telephone.

2. Description of the Related Art

Generally, when making a telephone call between two parties over the internet, it was necessary to startup a computer to have a Voice-over-IP (VoIP) function, to check the called IP address before making the call, then to enter the dialing number on the computer screen, and such series of complicated operations for making a call were troublesome.

Also, generally, in order to make a telephone call from a computer to a PSTN telephone, it was necessary to connect to the Signaling System 7 (SS7) network via large-scale equipment in a telecommunications company, and in order to make a telephone call from a PSTN telephone to a computer, it was necessary to connect to the IP address management system in the service providing company, and the complicated connecting operation to such network or system was troublesome.

For example, when making a call from a computer to a PSTN telephone, the caller had to perform troublesome processes of activating the internet telephone application on the computer, entering the called IP address or the telephone number associated to the IP address on the computer screen, and then re-entering the called telephone number for the Public Switched Telephone Network (PSTN) telephones.

Also, for example, when making a call from the PSTN telephones to a computer, it is necessary to prepare a special system for constantly managing the computer's IP address allocation status on the internet network, and at the present time such IP address management system has not yet been realized.

### SUMMARY OF THE INVENTION

It is the objective of this invention to provide an adequately simplified method of using a special internet-oriented IP telephone apparatus to automatically initiate or terminate telephone calls between two parties over the internet. Also, it is the objective of this invention to provide an adequately simplified method to automatically initiate or terminate telephone calls between a special internet-oriented IP telephone apparatus and a normal telephone terminal on the Public Switched Telephone Network.

In order to solve the aforementioned problems, this invention is provided with: a special internet-oriented IP telephone apparatus that makes it possible to send voice as data over the internet; an internet telephone connection management unit for managing the allocation status of the IP address of the internet-oriented IP telephone apparatus; and a telephone number automatic receiving/sending unit that can receive and send a telephone number between the internet-oriented IP telephone apparatus and a PSTN telephone terminal.

Moreover, in the internet telephone connection management unit, it is possible to effectively perform IP telephone communication by suitably applying: an IP address registration process for setting the internet-oriented IP telephone apparatus to a usable state; an owner information display process for displaying the owner information on the internet-oriented IP telephone apparatus; an IP address search process for searching the owner information in order to obtain the called destination IP address; an IP address output process for sending the found IP address to the caller's internet-oriented IP telephone apparatus; an IP address confirmation process for checking the connection status of the internet-oriented IP telephone apparatus; and an IP address deletion process for clearing the IP address column in the IP address database when the internet-oriented IP telephone apparatus becomes disconnected.

### BRIEF DESCRIPTION OF THE DRAWINGS

FIG. 1 is a schematic diagram of hardware for an internet IP telephone switching system in a preferred embodiment;

FIG. 2 is a state diagram showing the processing procedure for a telephone call from an IP telephone to an IP telephone in the internet IP telephone switching system;

FIG. 3 is a flowchart showing the processing procedure for a telephone call from an IP telephone to an IP telephone in the internet IP telephone switching system;

FIG. 4 is a state diagram showing the processing procedure for a telephone call from an IP telephone to a PSTN telephone in the internet IP telephone switching system;

FIG. 5 is a flowchart showing the processing procedure for a telephone call from an IP telephone to a PSTN telephone in the internet IP telephone switching system (No. 1);

FIG. 6 is a flowchart showing the processing procedure for a telephone call from an IP telephone to a PSTN telephone in the internet IP telephone switching system (No. 2);

FIG. 7 is a state diagram showing the processing procedure for a telephone call from a PSTN telephone to an IP telephone in the internet IP telephone switching system;

FIG. 8 is a flowchart showing the processing procedure for a telephone call from a PSTN telephone to an IP telephone in the internet IP telephone switching system;

FIG. 9 is a state diagram showing the processing procedure for the IP address management technique in the preferred embodiment;

FIG. 10 is a flowchart showing the processing procedure for registering the IP telephone connection state in the IP address management technique;

FIG. 11 is a flowchart showing the processing procedure before making an IP telephone call in the IP address management technique;

FIG. 12 is a flowchart showing the processing procedure for confirming the IP telephone connection state in the IP address management technique.

### DESCRIPTION OF THE PREFERRED EMBODIMENTS

Preferable embodiments of the present invention will be explained with reference to the drawings below.

The embodiments are applied to an internet IP telephone switching system comprised of: a special internet-oriented IP telephone apparatuses 1, 2 each having a DSP control unit 14, telephony parts unit 15, screen display unit 11, input operation unit 13, modulation/demodulation unit 12 and central control unit 10; an internet telephone connection management unit 4; and a telephone number automatic receiving/sending unit 5.

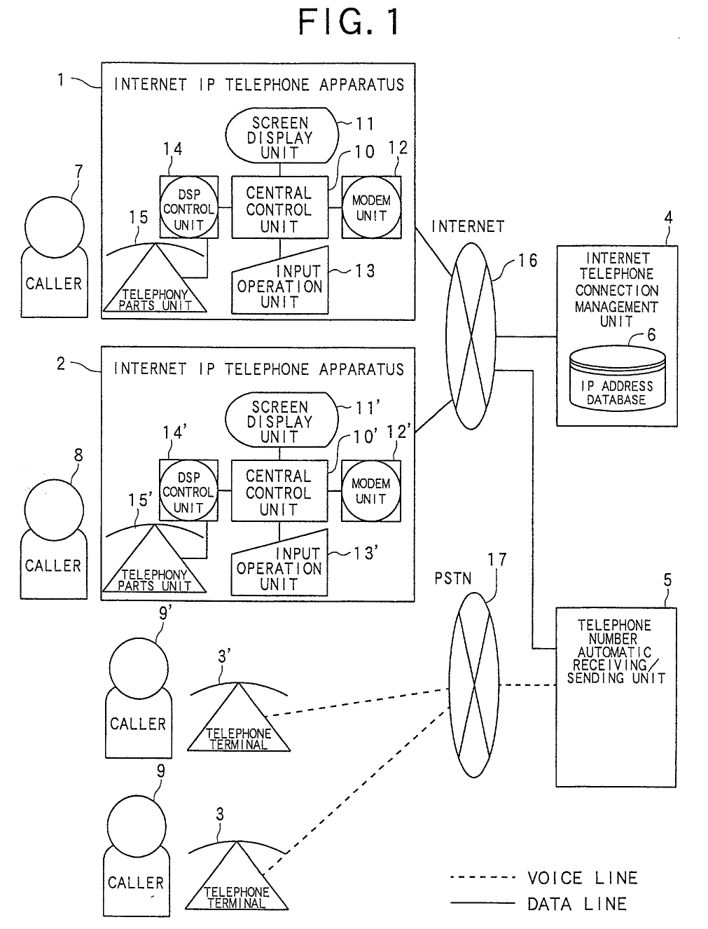

As shown in FIG. 1, a plurality of special internet-oriented IP telephone apparatuses are connected to the internet network 16 like the IP telephone apparatuses 1, 2, and a plurality of normal telephone terminals are connected to the Public Switched Telephone Network (PSTN) 17 like the telephone terminals 3, 3′. The internet telephone connection management unit 4 is connected to the internet network 16, and the telephone number automatic receiving/sending unit 5 is connected to both the internet network 16 and the PSTN 17, so it is possible to make a telephone call from an IP telephone 1 to an IP telephone 2, from an IP telephone 1 to a PSTN telephone 3, or from a PSTN telephone 3 to an IP telephone 1.

Also, in the special internet-oriented IP telephone apparatus l(or 2), the units such as the input operation unit 13 (or 13′), screen display unit 11 (or 11′), DSP control unit 14 (or 14′) and modulation-demodulation unit 12 (or 12′) are put together around the central control unit 10 (or 10′) in one box, including the telephony parts unit 15 (or 15′) via the DSP control unit 14 (or 14′). It is possible to connect to the internet network 16 from the modulation-demodulation unit 12 (or 12′).

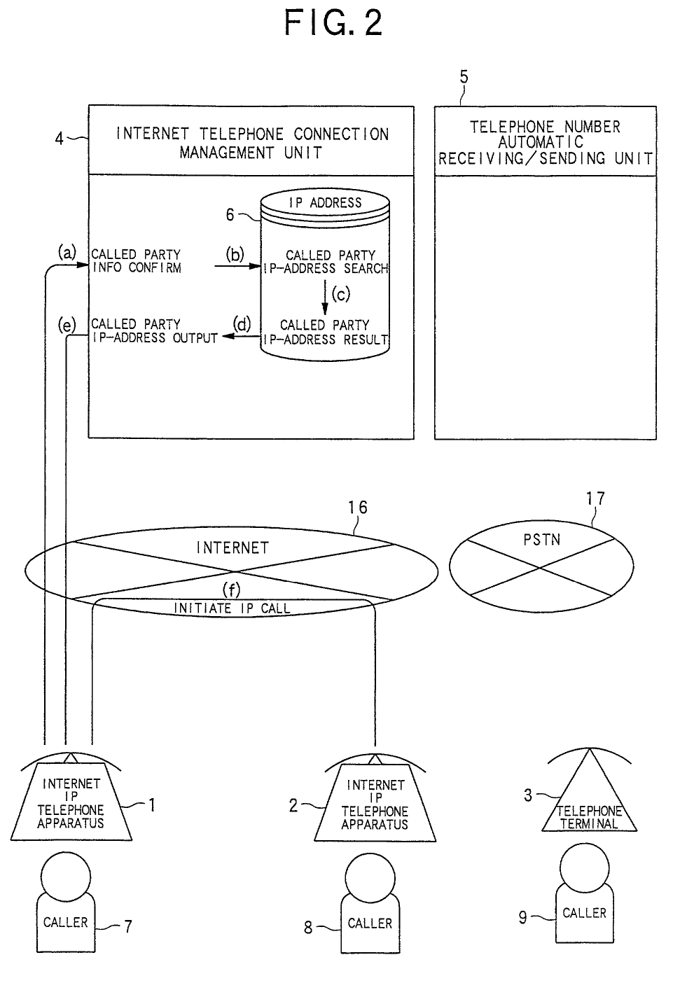

As shown in FIG. 2, when a caller 7 selects a called party based on owner information that is displayed on the screen display unit 11 in the special internet-oriented IP telephone apparatus 1, the internet telephone connection management unit 4 searches for the IP address of that called party. (See (a) and (b) in FIG. 2.)

And the internet telephone connection management unit 4 prepares for outputting the called party IP address that was found in the IP address database 6, and sends that address to the special internet-oriented IP telephone apparatus 1. (See (d) and (e) in FIG. 2.)

Furthermore, the special internet-oriented IP telephone apparatus 1 receives the called party IP address, and directly initiates an IP call to the special internet-oriented IP telephone apparatus 2 based on the received IP address. And when the special internet-oriented IP telephone apparatus 2 answers, the IP call between the special internet-oriented IP telephone apparatus 1 and the special internet-oriented IP telephone apparatus 2 is established to be communicable. (See (f) in FIG. 2.)

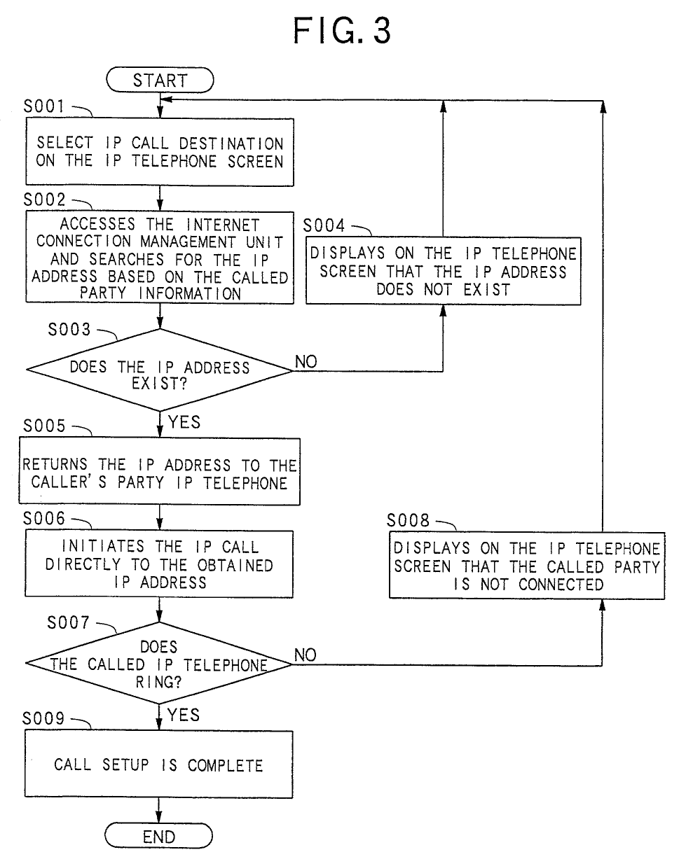

As shown in FIG. 3, by selecting one of the owner information or the internet telephone numbers displayed on the screen of the caller's IP telephone, the caller's IP telephone searches in the IP address database for the IP address of the selected IP telephone. (See S001 and S002 in FIG. 3.)

When the searched IP address is not found in the database, the caller's IP telephone displays on its screen that there is no associated IP address, and the processing flow returns repetitively to the process of selecting the called IP telephone. (See S003 and S004 in FIG. 3.)

When the associated IP address is found, the searched IP address is returned to the caller's IP telephone. After receiving the called party's IP address, the caller's IP telephone directly initiates the IP call. (See S005 and S006 in FIG. 3.)

In the case that the called party's IP telephone does not ring when the caller's IP telephone initiates the call, the caller's IP telephone displays on its screen that the called IP telephone is not connected. However, when the called IP telephone does ring, the IP call setup is completed. (See S007, S008 and S009 in FIG. 3.)

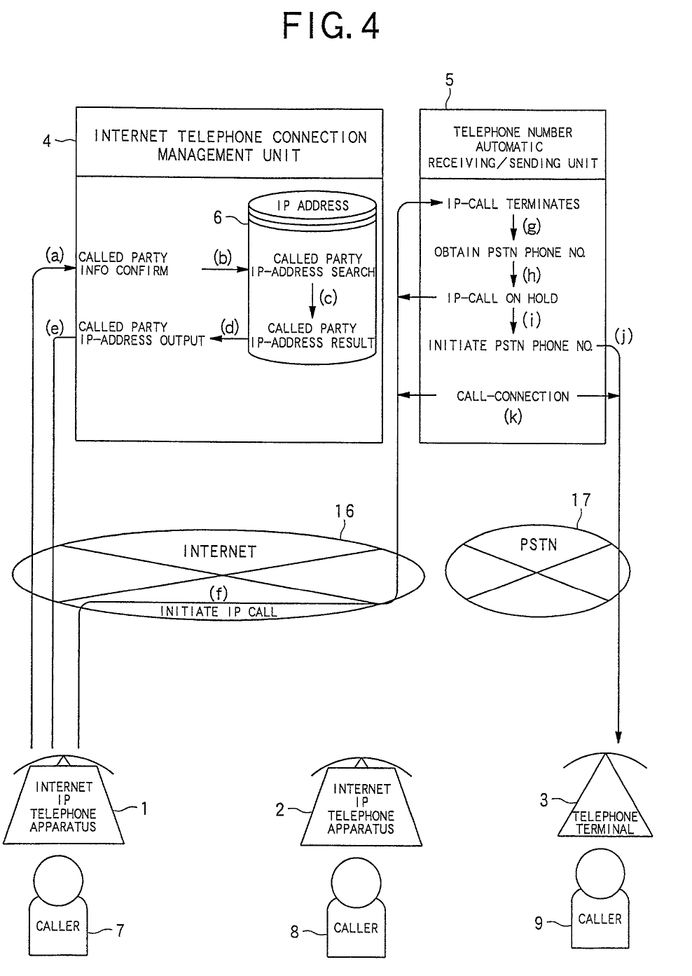

As shown in FIG. 4, when a caller 7 selects the telephone number automatic receiving/sending unit 5 displayed on the screen of the caller's special internet-oriented IP telephone apparatus 1, the internet telephone connection management unit 4 searches for the IP address associated to the automatic receiving/sending unit 5 of the called party. In the case that the final called party is a PSTN telephone terminal, the telephone number automatic receiving/sending unit is always selected for the IP call. (See (a) and (b) in FIG. 4.)

And the internet telephone connection management unit 4 prepares for outputting the IP address of the telephone number automatic receiving/sending unit 5 that was searched in the IP address database 6, and sends the IP address to the IP telephone apparatus 1. (See (c ), (d) and (e) in FIG. 4.)

Moreover, by using the received IP address of the called party, the special internet-oriented IP telephone apparatus 1 directly initiates an IP call to the telephone number automatic receiving/sending unit 5, and when the telephone number automatic receiving/sending unit 5 automatically answers, the IP call from the special internet-oriented IP telephone apparatus 1 terminates at the telephone number automatic receiving/sending unit 5. (See (f) in FIG. 4.)

In response to the arrived IP call, the telephone number automatic receiving/sending unit 5 plays voice guidance for obtaining the PSTN telephone number, and when a DTMF tone signal or spoken voice is gotten from the caller 7, the unit 5 obtains the telephone number to initiate a call on the PSTN 17. This is the process to recognize a PSTN telephone number to be initiated. (See (g) and (h) in FIG. 4.)

After obtaining the PSTN telephone number as the final called party, the IP call over the internet network 16 is temporarily put on hold, and then according to the PSTN telephone number previously obtained, a PSTN telephone call is separately made over the PSTN 17. This is the process to initiate a PSTN telephone call over the PSTN. (See (i) and (j) in FIG. 4.)

As soon as the PSTN telephone terminal 3 answers, by connecting the IP call over the internet network 16 with the PSTN call over the PSTN 17, the call between the special internet-oriented IP telephone apparatus 1 and the PSTN telephone terminal 3 becomes communicable. This is the process to connect the two calls. (See (k) in FIG. 4.)

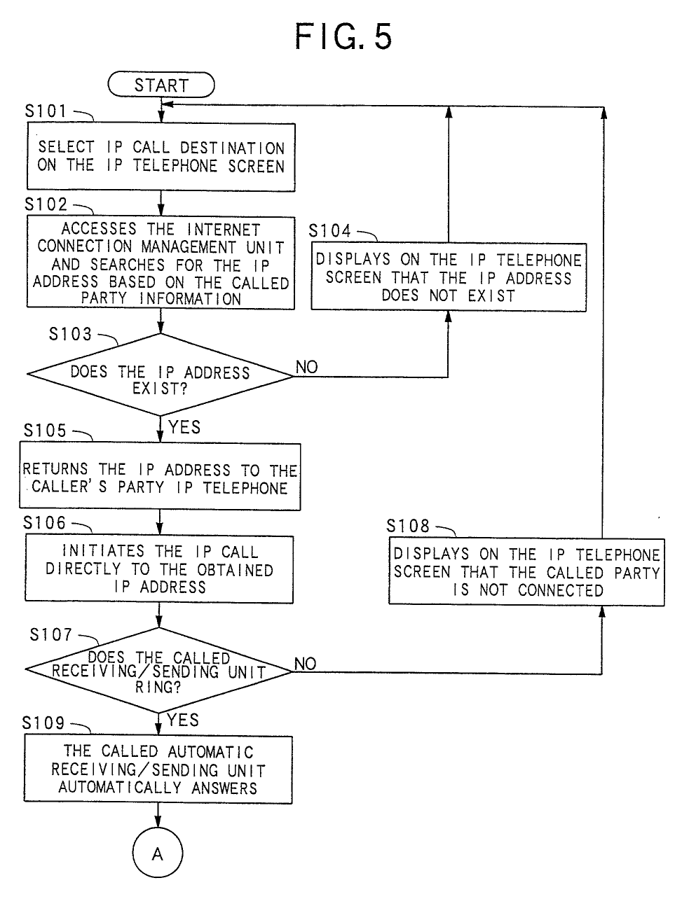

As shown in FIG. 5, out of the multiple automatic receiving/sending units that are displayed on the screen of the caller's IP telephone, the automatic receiving/sending unit being positioned nearest to the area of the called PSTN telephone is selected, and the IP address of the selected automatic receiving/sending unit is searched in the IP address database. (See S101 and S102 in FIG. 5.)

When the searched IP address is not found in the database, the caller's IP telephone displays on its screen that there is no associated IP address, and the processing flow returns repetitively to the process of selecting an automatic receiving/sending unit to be called. (See S103 and S104 in FIG. 5.)

When the associated IP address is found, the searched IP address is returned to the caller's IP telephone. After receiving the called party IP address, the caller's IP telephone directly initiates the IP call. (See S105 and S106 in FIG. 5.)

In the case that the called automatic receiving/sending unit does not ring when the caller's IP telephone initiates a call, the caller's IP telephone displays on its screen that the called unit is not connected. However, if the called automatic receiving/sending unit does ring, the unit automatically answers the call. (See S107, S108 and S109 in FIG. 5.)

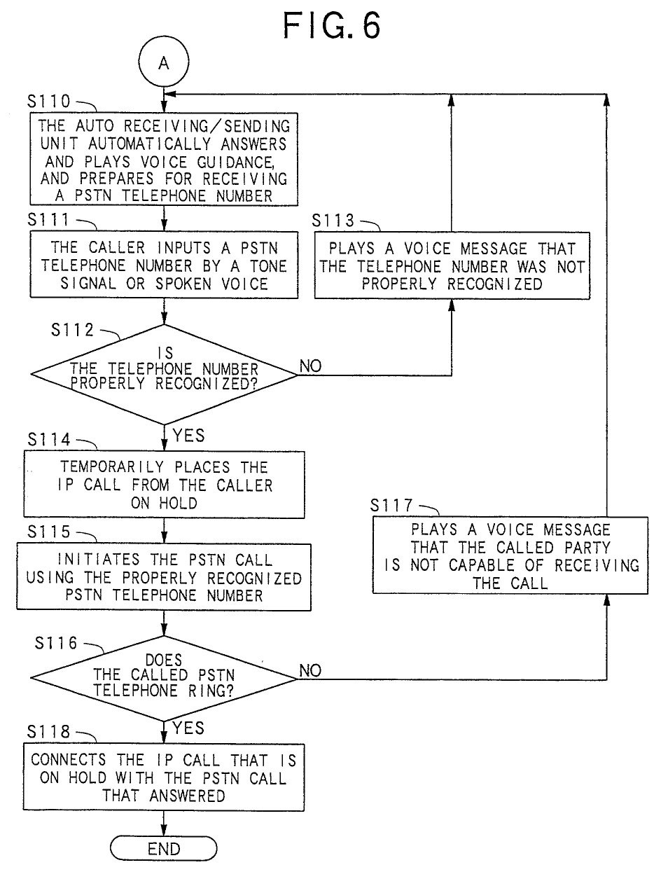

As shown in FIG. 6, after the automatic receiving/sending unit automatically answers the call, it plays voice guidance to the caller and waits for the telephone number of the PSTN telephone, which is the final called party, to be input by the caller. Input is performed by a DTMF tone signal or spoken voice. (See S110 and S111 in FIG. 6.)

When the automatic receiving/sending unit is not able to properly recognize the number, the unit plays a voice message to the caller's IP telephone indicating that the number recognized was incomplete, and the processing flow returns repetitively to the called number recognition process in the automatic receiving/sending unit. (See S112 and S113 in FIG. 6.)

When the automatic receiving/sending unit is able to properly recognize the number of the telephone to be finally called over the PSTN, the call from the caller's IP telephone is temporarily put on hold, and a PSTN call is separately initiated by the recognized telephone number over the PSTN. (See S114 and S115 in FIG. 6.)

When the PSTN telephone finally called over the PSTN does not ring, a voice message is played indicating that the called PSTN telephone is busy. When the PSTN telephone does ring, the IP call that was put on hold gets connected with the PSTN call at the instant the PSTN telephone answers. (See S116, S117 and S118 in FIG. 6.)

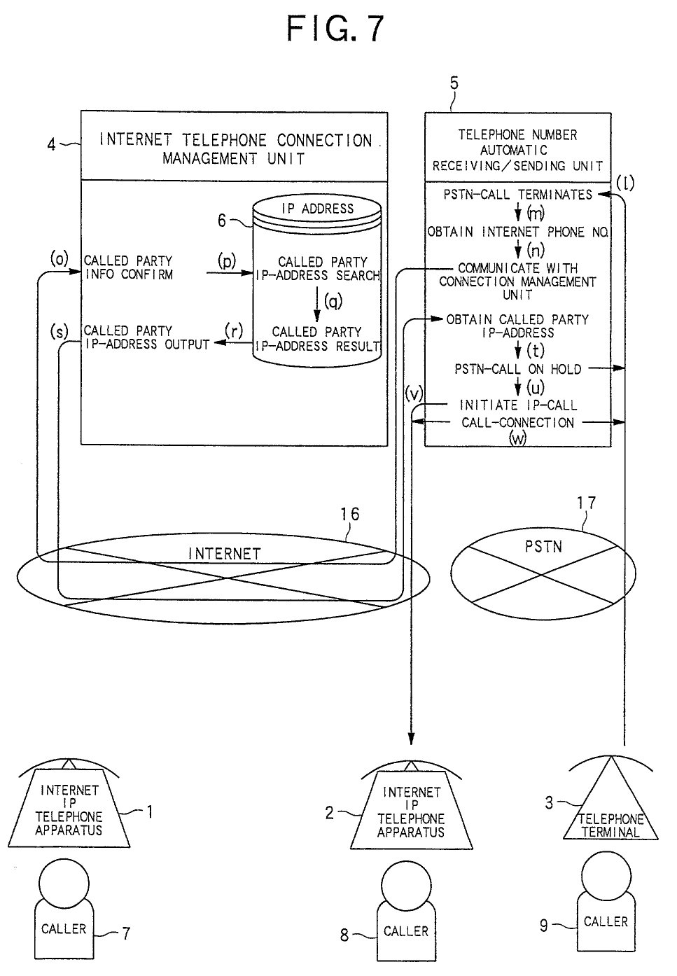

As shown in FIG. 7, when a caller 9 calls the telephone number automatic receiving/sending unit 5 by using a PSTN telephone terminal 3, the unit 5 automatically answers. (See (1) and (m) in FIG. 7.)

And in response to the terminated PSTN call, the telephone number automatic receiving/sending unit 5 plays voice guidance for obtaining an internet telephone number, and actually obtains the internet telephone number of the special internet-oriented IP telephone apparatus 2 on the internet network 16 by recognizing a DTMF tone signal or spoken voice of a caller 9. This is the process to recognize an internet telephone number to be initiated. (See (n) in FIG. 7.)

Moreover, the telephone number automatic receiving/sending unit 5 connects to the internet telephone connection management unit 4, and searches for the IP address associated the obtained internet telephone number. This is the process to search the IP address. (See (o) and (p) in FIG. 7.)

The internet telephone connection management unit 4 searches the IP address database 6 for the IP address that corresponds to the obtained internet telephone number, and returns the IP address to the telephone number automatic receiving/sending unit 5. (See (q), (r ) and (s) in FIG. 7.)

After obtaining the IP address of the special internet-oriented IP telephone apparatus 2 that is a final called party over the internet, the telephone number automatic receiving/sending unit 5 temporarily puts the call over the PSTN 17 on hold, and separately initiates an IP call to the obtained IP address over the internet network 16. This is the process to initiate an IP call over the internet. (See (t), (u) and (v) in FIG. 7.)

By connecting the PSTN call over the PSTN 17 with the IP call over the internet at the instant that the special internet-oriented IP telephone apparatus 2 answers, the call between the PSTN telephone terminal 3 and the special internet-oriented IP telephone apparatus 2 becomes communicable. This is the process to connect the two calls. (See (w) in FIG. 7.)

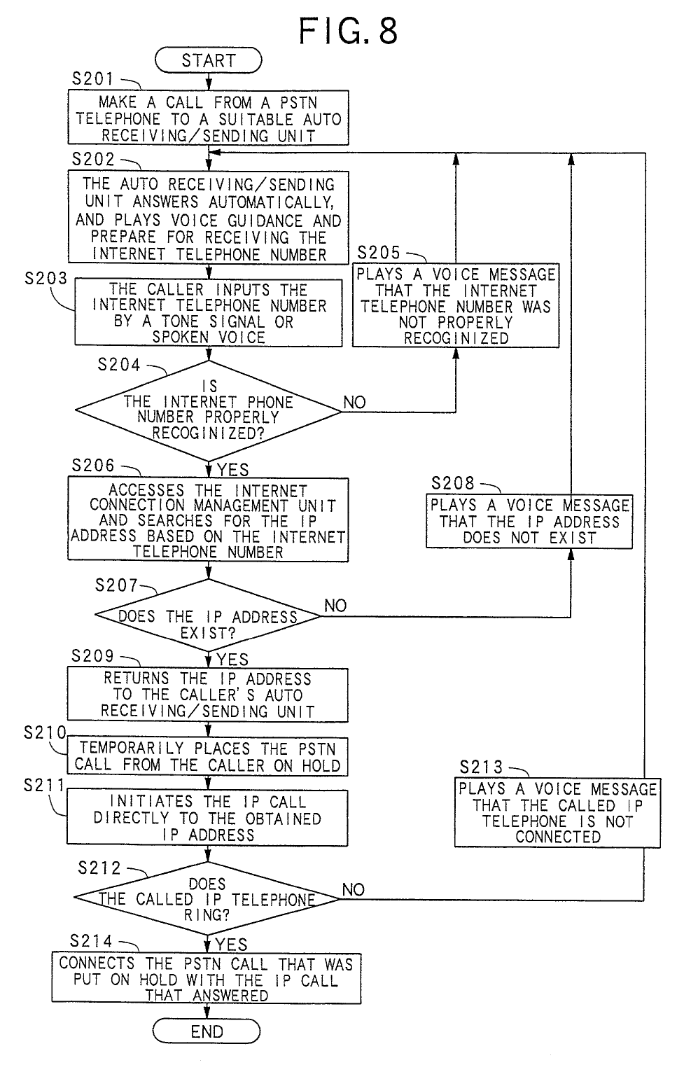

As shown in FIG. 8, a caller places a PSTN call to the telephone number of the location where the automatic receiving/sending unit is positioned nearest to the caller's PSTN telephone, and the unit automatically answers the PSTN call. (See S201 in FIG. 8.)

The automatic receiving/sending unit that automatically answers the call plays voice guidance, and waits for the internet telephone number of the IP telephone being the final called party over the internet to be input. The internet telephone number is input by a DTMF tone signal or by spoken voice. (See S202 and S203 in FIG. 8.)

When the automatic receiving/sending unit is not able to properly recognize the input, the unit plays a voice message to the caller's PSTN telephone indicating that the number recognition was incomplete, and repetitively asks for input of the internet telephone number of the called IP telephone. (See S204 and S205 in FIG. 8.)

When the automatic receiving/sending unit is able to properly recognize the input, the unit searches for the IP address in the IP address database based on the recognized internet telephone number. (See S206 in FIG. 8.)

When the IP address is not found in the IP address database, the automatic receiving/sending unit plays a voice message that the IP address could not be found and repetitively asks for input of the internet telephone number. (See S207 and S208 in FIG. 8.)

When the IP address is found, the IP address is returned to the automatic receiving/sending unit of the caller's party. When the unit receives the IP address, the unit temporarily puts the PSTN call on hold, and initiates an IP call directly to the called IP telephone. (See S209, S210 and S211 in FIG.

In the case of the called IP telephone does not ring when the caller's party automatic receiving/sending unit initiates the IP call, the unit plays a voice message indicating that the called IP telephone is not connected, and repetitively asks for input of the internet telephone number. However, when the called IP telephone does ring, the PSTN call being put on hold gets connected with the IP call at the instant the IP telephone answers. (See S212, S213 and S214 in FIG. 8.)

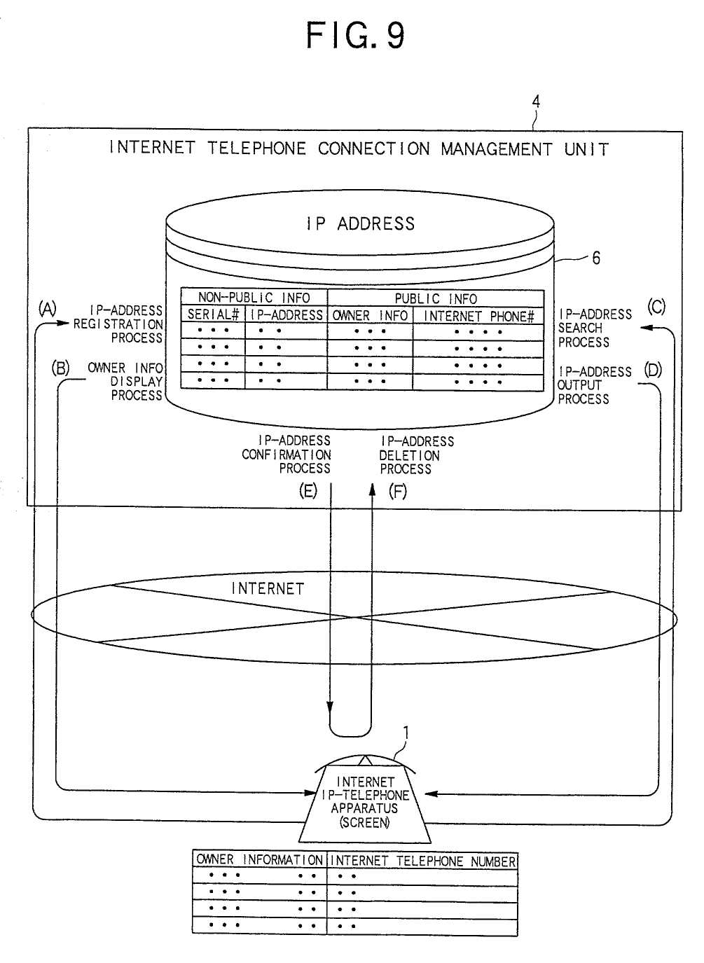

As shown in FIG. 9, the IP address management technique is comprised of: the IP telephone connection registration procedure, which includes the IP address registration process and the owner information display process; the IP telephone pre-call procedure, which includes the IP address search process and the IP address output process; and the IP telephone connection confirmation procedure, which includes the IP address confirmation process and the IP address deletion process.

The IP telephone connection registration procedure performs processing such as the process to newly register the IP address when the special internet-oriented IP telephone apparatus connects with the internet telephone connection management unit for the first time as well as the process to update the IP address when the IP telephone apparatus connects with the connection management unit each time after the first time, and the process to output and display to the special internet-oriented IP telephone apparatus the owner information and internet telephone numbers that are registered in the IP address database. (See (A) and (B) in FIG. 9.)

The IP telephone pre-call procedure performs processing such as the process to search the database for the latest IP address of either the special IP telephone apparatus or the automatic receiving/sending unit that is selected based on the owner information or the internet telephone number, and the process to prepare for automatic initiation of a call by returning the searched IP address of either the IP telephone apparatus or the automatic receiving/sending unit. (See (c and (D) in FIG. 9.)

The IP telephone connection confirmation procedure performs processing such as the process to confirm the IP telephone apparatus connection with the internet telephone connection management unit by the unit's sending the connection confirmation message, and the process to delete the IP address by clearing the IP address column in the IP address database when there is no response within a specified amount of time. (See (E) and (F) in FIG. 9.)

In the IP address database, there is an area for storing, as non-public information, the manufacturing serial number unique to every IP telephone apparatus and the IP address information associated to the apparatus, and there is an area for storing, as public information, the owner information of an IP telephone apparatus and the internet telephone number uniquely assigned to every IP telephone apparatus. Both of the non-public information and public information are applied similarly for the automatic receiving/sending unit as well.

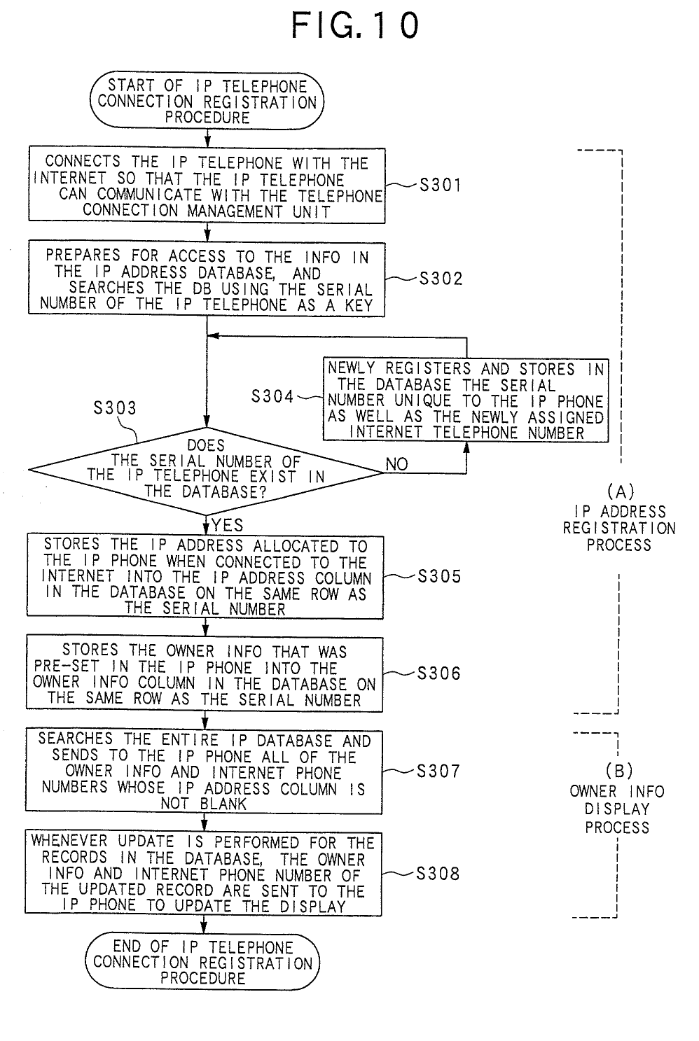

As shown in FIG. 10, the IP telephone gets connected in order to be able to communicate data over the internet network, and the IP telephone searches the IP address database with the unique serial number of its own as a key in the internet telephone connection management unit. (See S301 and S302 in FIG. 10.)

When there is no serial number of the IP telephone in the database, the serial number is newly registered with the internet telephone number that is automatically and uniquely assigned to the IP telephone. (See S303 and S304 in FIG. 10.)

Moreover, the IP telephone IP address obtained when connected to the internet network is written in the IP address column, and the owner information being preset in the IP telephone is written in the owner information column in the IP address database. This process is the IP address registration process. (See S305, S306 and (A) in FIG. 10.)

After the IP address registration process is completed, a full search of the IP address database is performed from the first record, and all of the public information of the other IP telephones currently connected to the internet are output to the IP telephone connected in the IP address registration process. (See S307 in FIG. 10.)

Since the processing above, every time an IP telephone is newly registered with a new serial number, or every time an IP address or owner information is updated in the IP address database, the public information of the IP telephone either newly registered or subsequently updated are output to the IP telephone that has been connected already. This process is the owner information display process. (See S308 and (B) in FIG. 10.)

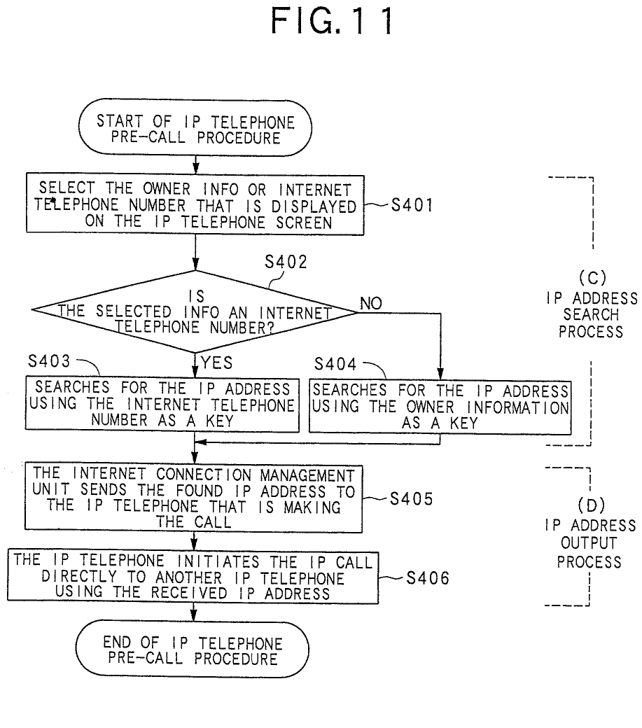

As shown in FIG. 11, based on either the public information displayed or the internet telephone number input on the screen of the caller's IP telephone, either the called IP telephone or the called automatic receiving/sending unit is selected. (See S401 in FIG. 11.)

Depending on the information input or selected, the IP address database is searched either as a key with the telephone number input in the case of internet telephone number, or as a key with the information in the case of owner information. This process is the IP address search process. (See S402, S403, S404 and (C ) in FIG. 11.)

By returning the found IP address either to the caller's IP telephone apparatus or the caller's party automatic receiving/sending unit, the apparatus or the unit that receives the IP address can initiate an IP call directly either to the called IP telephone apparatus or to the automatic receiving/sending unit. This process is the IP address output process. (See S405, S406 and (D) in FIG. 11.)

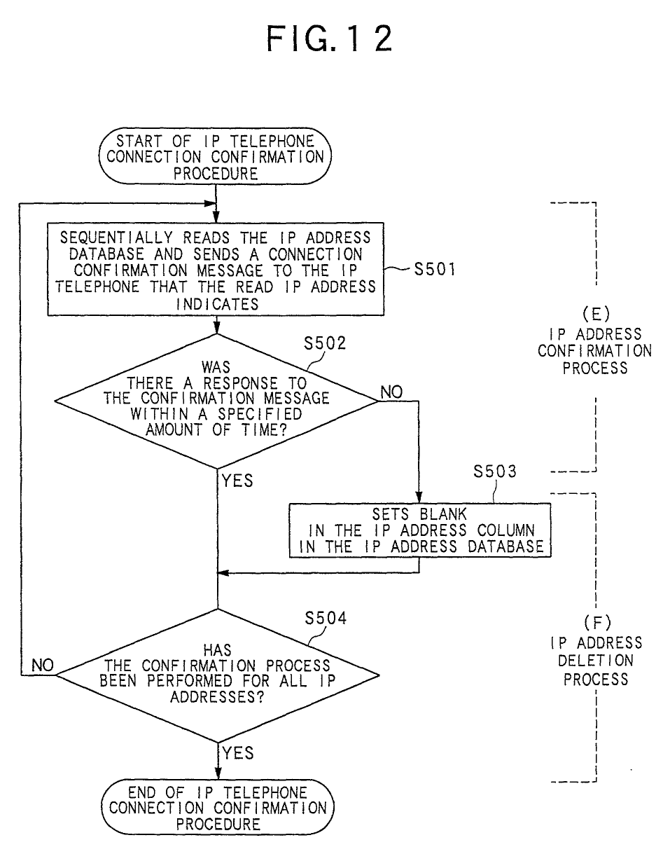

As shown in FIG. 12, the records in the IP address database is sequentially read from the first, and a connection confirmation message is sent to the IP telephones or the automatic receiving/sending units associated by the read IP address. (See S501 in FIG. 12.)

When there is a response to the sent connection confirmation message within a specified amount of time, it is checked whether or not connection confirmation has been performed for all records, and then the processing flow moves to the reading processing for the next record. This process is the IP address confirmation process. (See S502 and (E) in FIG. 12.)

When there is no response to the sent connection confirmation message within a specified amount of time, the associated IP address column in the IP address database is set blank. Setting the IP address blank is taken as an information update, and the associated information is removed from the display in the owner information display process. (See S503 in FIG. 12.)

After the connection confirmation has been performed for all records in the IP address database, the IP telephone connection confirmation procedure completes one cycle of the processing. This process is the IP address deletion process. (See S504 and (F) in FIG. 12.)

### EXAMPLES

Cases such as the case of making a call from a special internet-oriented IP telephone apparatus to another special internet-oriented IP telephone apparatus, the case of making a call from a special internet-oriented IP telephone apparatus to a PSTN telephone terminal, and the case of making a call from a PSTN telephone to a special internet-oriented IP telephone apparatus will be explained as actual examples referring to FIG.1.

When making a call from an IP telephone to another IP telephone, the caller 7 views the owner information and internet telephone numbers displayed on the screen of the IP telephone 1 and selects an IP telephone as the called party and starts the processing to initiate the call by pressing one key on the input operation unit of the IP telephone 1.

When the IP telephone 2 is selected as the called party, the caller's IP telephone 1 uses the owner information and internet telephone number of the IP telephone 2 as a key to search the IP address database and obtain the IP address of the called IP telephone 2, then the IP telephone 1 initiates the call directly to the IP telephone 2.

The IP telephone 2 rings when the call terminates at the telephone, and when the caller 8 picks up the handset, the call gets established. The call will be disconnected at the instant when either the caller 7 or the caller 8 hangs up the handset.

When making a telephone call from an IP telephone to a PSTN telephone, judging from the owner information and internet telephone numbers that are always displayed on the screen of the IP telephone 1, the caller 7 selects, as a first-step called party, an automatic receiving/sending unit 5 which has the same area code “03” as the PSTN telephone that is a final called party, and then starts the processing to initiate the call by pressing one key on the input operation unit.

After the called automatic receiving/sending unit 5 has been selected, the caller's IP telephone 1 uses the owner information and the internet telephone number of the selected unit 5 as a key to search the IP address database 6 and obtain the IP address of the called automatic receiving/sending unit 5, then the IP telephone 1 initiates the IP call directly to the automatic receiving/sending unit 5.

The automatic receiving/sending unit 5 automatically answers when the call terminates at the unit, and using voice guidance, asks for input of the telephone number of the PSTN telephone that is the final called party, and when the caller 7 speaks out “0312345678” (zero-three-one-two-three-four-five-six-seven-eight), the telephone number of the final called party is recognized.

And the automatic receiving/sending unit 5 temporarily puts the IP call from the caller 7 on hold, then automatically initiates a PSTN call to the PSTN telephone terminal 3 having the number obtained in the voice recognition, and when the caller 9 picks up the handset of the ringing PSTN telephone terminal 3, the automatic receiving/sending unit 5 connects the IP call that was put on hold with the PSTN call that the PSTN telephone 3 answered, and the call connection is established. The call will be disconnected at the instant when either the caller 7 or the caller 9 hangs up the handset.

When making a call from a PSTN telephone 3 to an IP telephone 8, the caller 9 picks up the handset of the PSTN telephone terminal 3 and selects an automatic receiving/sending unit 5 that has the same area code “03” as the PSTN telephone terminal 3, and starts the processing to initiate the call by keying in the telephone number of the automatic receiving/sending unit 5.

The automatic receiving/sending unit 5 automatically answers when the call terminates at the unit, and using voice guidance, the unit asks for inputting the telephone number of the IP telephone 2 that is the final called party, and when the caller 9 speaks out the number “000112345678” (zero-zero-zero-one-one-two-three-four-five-six-seven-eight), the internet telephone number of the final called party is recognized.

After the automatic receiving/sending unit 5 recognizes the internet telephone number, the unit uses the recognized internet telephone number as a key to search the IP address database and to obtain the IP address for the called IP telephone 2, then the automatic receiving/sending unit 5 temporarily puts the PSTN call from the caller 9 on hold and automatically initiates the IP call to the IP telephone 2.

And at the instant that the caller 8 picks up the handset of the ringing IP telephone 2, the automatic receiving/sending unit 5 connects the PSTN call that was put on hold with the IP call that was answered, and establishes the total call. The call will be disconnected at the instant when either the caller 8 or the caller 9 hangs up the handset.

As described above, there are three possible ways of making a call: from an IP telephone to another IP telephone, from an IP telephone to a PSTN telephone, and from a PSTN telephone to an IP telephone, and by going through two automatic receiving/sending units, it is further possible to make a call from a PSTN telephone to another PSTN telephone over the internet network.

This invention has the following effects when embodied as explained above.

(1) It is possible to make or receive calls between one IP telephone and another IP telephone over the internet, and since the internet normally has an all-time connection billing service, it is possible to make a calling fee a fixed charge regardless of the distance or length of the call.

(2) It is possible to make a call from an IP telephone to a PSTN telephone, and the PSTN call portion from the automatic receiving/sending unit to the PSTN telephone eventually can be shortened as a local call, so it is possible to reduce calling charges.

(3) It is possible to make a call from a PSTN telephone to an IP telephone, and since the internet telephone number is valid regardless the physical line that is connected, it is always possible to make a call to a specified IP telephone using a specified internet telephone number regardless of the location of the line connected between the IP telephone and internet network.

(4) It is possible to make a call from a PSTN telephone to a PSTN telephone over the internet network, and since the internet is alternatively used for transmission of the call in the middle, it is possible to make a long-distance call by way of two local calls.

(5) The special internet-oriented IP telephone apparatus is designed as a special apparatus, and since there is no start-up time or complicated operations such as for a computer, the IP telephone apparatus can be connected to the internet and be used easily at anytime.

(6) The special internet-oriented IP telephone apparatus is used especially for Voice-over-IP (VoIP) calls and is not easily susceptible to illegal access from the outside over the internet network, and thus the apparatus is very highly secured.

(7) The special internet-oriented IP telephone apparatus has a screen display unit, and it is possible to select the telephone number of the called party on the screen, so the calls can be initiated easily without having to key in every telephone number digit.

(8) The special internet-oriented IP telephone apparatus has an input operation unit and a screen display unit, so input of various settings is simple, and internet browsing is also possible, therefore it is possible to display advertisements over the internet while the telephony function is not being used.

(9) The special internet-oriented IP telephone apparatus has a DSP control unit and telephony parts unit making it possible for the apparatus hardware to perform telephony controls and voice compression-decompression at high speed, thus the telephony operation is simple and sound delay does not occure.

(10) The special internet-oriented IP telephone apparatus has a modulation-demodulation unit that is replaceable with modulation-demodulation units of various specifications in order to satisfy the internet connection requirements, so the IP telephone apparatus can be connected to the Internet in a simple fashion.

(11) The internet IP telephone switching system uses the internet as the standard communication network, and because the switching system uses a widely spread internet network, it is possible to minimize calling charges.

(12) The internet IP telephone switching system uses the internet as the standard communication network, and because the switching system works just by adding an internet telephone connection management unit, it is possible to start a telecommunications business easily.

(13) The internet IP telephone switching system uses the internet as the standard communication network, and because the switching system can have the units such as the special internet-oriented IP telephone apparatus, the internet telephone connection management unit and the telephone number automatic receiving/sending unit in various locations around the internet, it is possible to move the system facilities location easily.

(14) The internet telephone connection management unit has an owner information column in the IP address database, and it is possible to search the IP address with the browser software, so it is possible to make a telephone call to a party whose telephone number is not known.

(15) The internet telephone connection management unit periodically performs the IP address confirmation process, and the unit periodically sends the confirmation message to the special internet-oriented telephone apparatus, so it is possible to transfer internet advertisement data in the same timing.

(16) The telephone number automatic receiving/sending unit has a voice recognition function so it is possible to input the telephone number by spoken voice as well as by a DTMF tone signal, and thus it is possible to simplify the telephone calling operation.

(17) The telephone number automatic receiving/sending unit connects both the Public Switched Telephone Network and the internet network, so it is possible to connect a PSTN call over cellular telephone, PCS telephone, stationed telephone or public pay telephone with an IP call over the internet network.

The invention may be embodied in other specific forms without departing from the spirit or essential characteristics thereof. The present embodiments are therefore to be considered in all respects as illustrative and not restrictive, the scope of the invention being indicated by the appended claims rather than by the forgoing description and all changes which come within the meaning and range of equivalency of the claims are therefore intended to be embraces therein.

The entire disclosure of Japanese Patent Application No. 2001-75026 filed on Feb. 9, 2001 including the specification, claims, drawings and summary is incorporated herein by reference in its entirety.

What is claimed is:

1. An internet-oriented IP telephone switching system that makes it possible to make voice communication over the internet by connecting to the internet network, comprising:
a special internet-oriented IP telephone apparatus having a DSP control unit, a telephony parts unit, a screen display unit, an input operation unit, a modulation-demodulation unit and a central control unit;
an internet telephone connection management unit for managing the allocation status of IP address when the internet-oriented IP telephone apparatus is connected to the internet network; and
a telephone number automatic receiving/sending unit having functions to automatically receive and send a telephone number of a call between the internet-oriented IP telephone apparatus and a Public Switched Telephone Network (PSTN) telephone over the internet network.

2. A special internet-oriented IP telephone apparatus capable of making voice calls over the internet when connected to the internet network, comprising:
a DSP control unit that can receive or send DTMF tone signals;
a telephony parts unit that has a handset and telephone number dial pad;
a screen display unit that can instantly and automatically display the IP address allocation status;
an input operation unit that has a keyboard for entering various setting data;
a modulation-demodulation unit that can handle data communication by connecting to the internet network; and
a central control unit where the program constantly and comprehensively runs for controlling all of the units.

3. An internet telephone connection management method of managing the IP address allocation status of an internet-oriented IP telephone apparatus necessary for making a voice call over the internet when connected to the internet network, comprising:
an IP address registration process of registering to the IP address database the IP addresses that are allocated to the IP telephone apparatuses when connecting to the internet in order to make the apparatuses ready for use;
an owner information display process of displaying all of the owner information to the respective IP telephone apparatuses that are registered in the IP address database;
an IP address search process of searching the owner information of all the IP telephone apparatuses that are registered in the IP address database to obtain the IP address of the called party IP telephone apparatus;
an IP address output process of sending the searched IP address to the caller's IP telephone apparatus in order to make it possible for the caller's IP telephone apparatus to directly initiate a call to the other;
an IP address confirmation process of checking the connection status by sending a connection confirmation message to the IP telephone apparatus connected; and
an IP address deletion process of setting the IP address column in the database blank when there is no response within a specified amount of time to the sent connection confirmation message.

4. A telephone number automatic receiving/sending method of receiving and sending the telephone number between an internet-oriented IP telephone apparatus that is connected to the internet network, and a PSTN telephone that is connected to the Public Switched Telephone Network, comprising:
a called number recognition process of recognizing the telephone number of the called party by a DTMF tone signal or spoken voice;
an IP address search process of searching the IP address database based on the recognized telephone number;
a PSTN calling process of automatically initiating a call to the PSTN telephone while keeping the other IP call over the internet on hold;
an IP calling process of automatically initiating an IP call to the internet-oriented IP telephone apparatus on the internet while keeping the other PSTN call on the Public Switched Telephone Network on hold; and
a call connection process of connecting the incoming call that was temporarily put on hold with another outgoing call that was subsequently initiated.

5. A recording medium on which an internet-oriented IP telephone switching program is recorded in the form of being able to run on a computer processor in order for the program to make it possible to make voice communication over the internet by connecting to the internet network, the program causing the computer processor to function as:
an internet-oriented IP telephone apparatus having a DSP control unit, a telephony parts unit, a screen display unit, a input operation unit, a modulation-demodulation unit and a central control unit;
an internet telephone connection management unit for managing the allocation status of IP addresses when the special internet-oriented IP telephone apparatus is connected to the internet network; and
a telephone number automatic receiving/sending unit having functions to automatically receive and send a telephone number of a call between the internet-oriented IP telephone apparatus and a Public Switched Telephone Network (PSTN) telephone over the internet network.
